(19) United States
(12) Patent Application Publication
(10) Pub. No.: US 2007/0195490 A1
(43) Pub. Date: Aug. 23, 2007

(54) Apparatus And Method For Attaching An Electronic Module To A Lock Assembly

(76) Inventor: Sean V. Howell, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/674,393

(22) Filed: Feb. 13, 2007

Related U.S. Application Data
(60) Provisional application No. 60/772,700, filed on Feb. 13, 2006.

(51) Int. Cl. H02B 1/00

(52) U.S. Cl. 361/600

(57) ABSTRACT

An apparatus and method are disclosed for engaging an electronic module with a lock assembly. The electronic module may have a first end with an electronic circuit disposed therein and a second end with a slot extending therethrough. At least one profile may be formed in the slot and at least one profile may be formed in exterior portions of the lock assembly. Each profile of the slot may be engaged with a profile of the lock assembly. At least one engagement device may be disposed in the electronic module to releasably engage the electronic module with the lock assembly.

### RELATED APPLICATIONS

This application claims the benefit of U.S. provisional application No. 60/772,700 entitled “Apparatus And Method For Attaching an Electronic Module to a Lock Assembly” filed Feb. 13, 2006.

This application is related to copending patent application entitled “Apparatus And Method For Controlling And Monitoring Access To A Storage Container”, application Ser. No. 11/425,579, filed Jun. 21, 2006 claiming priority to U.S. Provisional Patent Application Ser. No. 60/772,744 filed Feb. 13, 2006 and copending patent application entitled “Apparatus And Method For Controlling Access To Remotely Located Equipment”, application Ser. No. 11/277,272, filed Mar. 23, 2006 claiming priority to U.S. Provisional Patent Application Ser. No. 60/729,106 Filed Oct. 22, 2005.

### TECHNICAL FIELD

The present disclosure is related to apparatus and methods for attaching electronic modules to portions of a lock assembly and more particularly to engaging an electronic module with a lock assembly having at least one profile operable to be received within at least one profile associated with the electronic module.

### BACKGROUND

A wide variety of mechanical locks, electrical lock and/or electromechanical locks have been used to releasably engage doors, covers and other types of closures with associated cabinets, door frames, boxes and other structures. For example, vending machines often include mechanical or electromechanical lock assemblies to releasably engage a door with other portions of the vending machine. Such lock assemblies may include a key operated T-handle type locking device. Such locking devices may be used to releasably engage a door with an associated frame by inserting a portion of the T-handle through the door and into an opening in the frame of the vending machine or other types of remotely located equipment.

Lock assemblies associated with modern vending machines may include a generally T-shaped handle having a mechanical locking device and/or an electronic locking device. A conventional key may be used to operate portions of a mechanical locking structure to engage (lock) or disengage (unlock) the handle to prevent (locked) or allow (unlocked) rotation of an associated lock screw or locking post extending from the handle. An electronic circuit or circuits mounted on interior portions of an associated vending machine may be used to engage and disengage portions of an electronic locking structure to prevent or allow rotation of an associated lock screw or locking post using the handle.

### SUMMARY

In accordance with teachings of the present disclosure various problems and disadvantages associated with attaching electronic modules with locking devices and lock assemblies may be substantially reduced or eliminated. For some applications an electronic circuit and an associated locking device may cooperate with each other to prevent unauthorized access to remotely located equipment including, but not limited to, vending machines. For other applications multiple electronic circuits may be used to prevent unauthorized access to remotely located equipment. One example of an apparatus having multiple electronic circuits may generally be described as an “access control module” (ACM) operable to prevent unauthorized operation of an associated locking device or lock assembly. A wide variety of electronic circuits may be used to operate a locking device or lock assembly.

For some applications an electronic module may include a housing having a first portion with one or more electronic circuits disposed therein for use in controlling one or more functions of an associated locking device or lock assembly. A slot may be formed in a second portion of the housing proximate the first portion containing the electronic circuits. The slot may be sized to receive portions of the locking device or lock assembly therein. At least one engagement device may be disposed in the housing for use in releasably engaging the electronic module with the locking device or lock assembly.

For some embodiments various components of an electronic module, such as electronic circuits and a solenoid or other type of electrical actuator, may be disposed within one portion of a housing. A slot may be formed in another portion of the housing proximate the solenoid or other type of electrical actuator. At least one profile may be formed within the slot and at least one matching profile may be formed on exterior portions of the locking device or lock assembly. For some applications a pair of profiles may be formed within opposite sides of the slot. Matching profiles formed on exterior portions of the locking device or lock assembly may be slidably received within respective profiles of the slot. Respective engagement devices may be formed within one end of the housing adjacent to the pair of profiles formed in the slot for use in releasably engaging the electronic module with the lock assembly.

Technical benefits may include, but are not limited to, releasably engaging portions of an electronic module with portions of a locking assembly without deforming the portions engaged with each other.

Further technical benefits may include, but are not limited to, modifying a conventional locking device or lock assembly normally operated by a mechanical key to accommodate operation by an electronic module attached to the conventional locking device or lock assembly.

All, some, or none of these technical advantages may be present in various embodiments of the present disclosure. Other technical benefits may be readily apparent to one skilled in the art from the following figures, descriptions and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a schematic drawing showing one example of a system operable to communicate information between remotely located equipment and a network operations center for various functions including, but not limited to, controlling access to the remotely located equipment;

FIG. 2 is a schematic drawing showing an exploded, isometric view with portions broken away of a vending machine and an associated lock assembly;

FIG. 3 is a schematic drawing showing an isometric view with portions broken away of a lock assembly and one example of an electronic module engaged with the lock assembly in accordance with some teachings of the present disclosure;

FIG. 4 is a schematic drawing showing an isometric view of an electronic module having a housing which may be releasably engaged with a lock assembly in accordance with some teachings of the present disclosure;

FIG. 5 is an isometric drawing showing one example of a lock assembly housing having exterior portions which may be releasably engaged with the electronic module of FIG. 4;

FIG. 6 is a schematic drawing in section taking along lines 6-6 of FIG. 5; and

FIG. 7 is an exploded, schematic drawing with portions broken away showing various components of the lock assembly and electronic module of FIG. 4.

### DETAILED DESCRIPTION OF THE DISCLOSURE

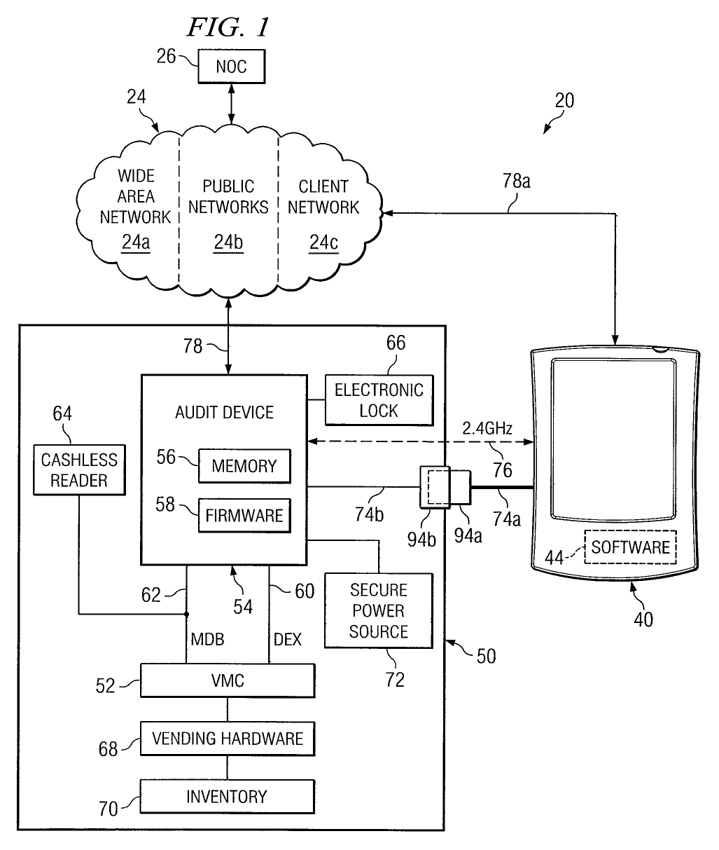

Preferred embodiments and various advantages of the disclosure may be understood by reference to FIGS. 1-7, wherein like numbers may refer to same or like parts.

Some aspects of the present disclosure may be described with respect to a vending machine, a vending machine controller, an electromechanical lock assembly and an access control module. However, various features and aspects of the present disclosure may be satisfactorily used to engage a wide variety of electronic modules or any other type of electronic device with an equally wide variety of locking devices and lock assemblies. Lock assemblies and associated electronic modules may be satisfactorily used with a wide variety of enclosures including, but not limited to, remotely located equipment. Various aspects of the present disclosure may be satisfactorily used with a wide variety of locks, lock assemblies and locking devices.

The term “remotely located equipment” may include, but is not limited to, vending machines, snack machines, beverage machines, automatic teller machines (ATMs), postage stamp dispensers, parking meters, electronic highway toll booths, arcade games, slot machines, laundry machines or any other type of equipment which may be satisfactorily used to provide goods and/or services.

The term “electromechanical lock assembly” may be used to describe a locking device or lock assembly having mechanical components and electronic components. The electronic components may include one or more electronic circuits and a solenoid, linear actuator or other suitable electronic components which may be used to engage (lock) or disengage (unlock) one or more mechanical components.

The terms “command” and “actuation code” may be used to describe various types of electronic signals or digital signals which may be used to actuate one or more components of an electronic circuit disposed within a housing formed in accordance with teachings of the present disclosure. Various types of electronic circuits and digital protocols may be satisfactorily used to actuate such electronic circuits and/or other components of an associated locking device. One example of electronic circuits, command codes and other components associated with engaging and/or disengaging a locking device are described in copending U.S. patent application Ser. No. 11/277,272 filed Mar. 23, 2006 entitled “Apparatus and Method for Controlling Access to Remotely Located Equipment.”

FIG. 1 is a schematic drawing showing a block diagram of remotely located equipment. However, apparatus incorporating teachings of the present disclosure may be used with remotely located equipment which does not include portions of a system for collecting, storing and communicating data and other information associated with operation of the remotely located equipment.

The data may include inventory levels, status of various components associated with the remotely located equipment and transactions conducted at the remotely located equipment. Examples of such transactions may include, but are not limited to, locking and unlocking a door to gain access to interior portions of the remotely located equipment. However, apparatus incorporating teachings of the present disclosure may be satisfactorily used to engage an electronic module with a lock assembly associated with remotely located equipment which does not have a vending machine controller and/or an audit device. Apparatus and methods incorporated teachings of the present disclosure may be used to engage an electronic module to a lock assembly wherein one or more electronic circuits in the electronic module may respond to a handheld device without the use of any other electronic components or systems.

System 20 may be satisfactorily used with vending machine 50 and other types of remotely located equipment to monitor and record inventory levels, product sales and operating status of associated mechanical and/or electrical components. System 20 may include network operations center 26, one or more handheld devices 40 and one or more vending machines 50. For some applications handheld device 40 may be a handheld computer or personal data assistant (PDA).

Various communication networks and communication techniques may be satisfactorily used to communicate data and other information between the various components associated with system 20. Examples of such communication networks may include, but are not limited to, wide area networks 24a, public communication networks 24b and client networks or private networks 24c. Each of these networks may include a wide variety of wire-line transmission techniques and/or wireless transmission techniques. For example, public communication networks 24b may include, but are not limited to, a public switched telephone network (PSTN), the Internet, IP telephony or voice over IP (VoIP), cable networks and a wide variety of wireless networks which are being developed in many communities for access by the general public. The boundary lines or dividing lines between “conventional” wide area networks, public communication networks and client networks or private networks are subject to substantial variations, overlaps and rapid change as communication technology and techniques are developed.

Vending machine 50 may include vending machine controller (VMC) 52 operable to control and monitor various electronic components and mechanical components associated with vending machine 50. Vending machine 50 may also include audit device 54 or similar components such as a general purpose computer with wireless and/or wire-line communication capabilities.

For some applications, audit device 54 may be operable to obtain DEX data via DEX interface or communication link 60 from vending machine controller 52. Audit device 54 may automatically collect DEX data and equipment operating status according to predefined collection criteria. Audit device 54 may store such audit data with associated timestamps to record occurrence times for individual events and conditions within the remotely located equipment.

Audit device 54 may also receive authentication information from a laptop computer (not expressly shown), handheld device 40 or any other electronic component operable to communicate with audit device 54. In response to the authentication information, audit device 54 may test the authentication information for validity. After receiving valid authentication data, audit device 54 may synchronize a clock in audit device 54 with a clock in handheld device 40 and transfer at least a portion of the audit data to handheld device 40. The audit data may be transmitted by one or more communication techniques from handheld device 40 to network operation center 26 for recording and analysis of various functions at the remotely located equipment. Such functions may include, but are not limited to, unlocking a door to provide access for servicing the remotely located equipment and locking the door upon completion of servicing the remotely located equipment.

Vending machine 50 may include one or more hardware devices or peripheral devices. Cashless reader 64 may be representative of such hardware devices and peripherals. Cashless reader or cashless media device 64 may be operable to accept noncash payment tokens such as credit cards, RFID (Radio Frequency Identification Devices) or other media representative of noncash payment.

Vending machine 50 may include electronic lock 66 which may be operably coupled with audit device 54 via an electronic module (not expressly shown in FIG. 1). Audit device 54 may be operable to send commands or actuation codes to the electronic module to engage or disengage electronic lock 66. For example, audit device 54 may receive a command from handheld device 40 to initiate a sequence for unlocking or disengaging electronic lock 66. The unlocking sequence may include a request from audit device 54 to the electronic module to obtain a serial number associated with the electronic module and/or electronic lock 66. Audit device 54 may use the serial number to confirm that an electronic key or signal may be used to disengage electronic lock 66 and allow opening an associated door of vending machine 50.

Vending machine 50 may also include vending hardware 68 and vending inventory 70. Examples of vending machine hardware 68 may include, but are not limited to, inventory dispensing apparatus, one or more coin acceptance and verification mechanisms, one or more bill acceptance and validation mechanisms or any other hardware device associated with vending machines.

Vending machine 50 may also include secure power source 72 such as a battery operably coupled to audit device 54. For some applications secure power source 72 may also provide power to an electronic module associated with electronic lock 66 in the event of power failure to vending machine 50 or as may be appropriate at other selected time periods. Secure power source 72 may include one or more suppression and power conditioning devices operable to help guard against unauthorized access to vending machine 50. As shown in FIG. 1, secure power source 72 may be connected with audit device 54 such that audit device 54 may receive power from secure power source 72 as needed.

Handheld device 40 may be operable to communicate with audit device 54 using software 44 and a wide variety of wire-line transmission techniques and/or wireless transmission techniques. For example, communication cable 74a may be used to communicate between handheld device 40 and audit device 54. Wire-line 74b may extend between audit device 54 and communication port 94b. Communication plug 94a attached to one end of communication cable 74a may be operably engaged with communication port 94b. Handheld device 40 and audit device 54 may also communicate with each other using wireless communication techniques 76.

For some applications handheld device 40 may directly communicate with an electronic circuit operably engaged with a lock assembly by apparatus incorporating teachings of the present disclosure. For such applications (not expressly shown) handheld device 40 may lock (engage) and unlock (disengage) the lock assembly to control access to associated remotely located equipment.

Handheld device 40 and audit device 54 may be equipped with one or more wireless transceivers (not expressly shown). Examples of wireless communications that may be satisfactorily used with handheld device 40 and audit device 54 include, but are not limited to, Bluetooth, IEEE802.11a, IEEE802.11b and IEEE802.11g. To enable vending machine 50 to communicate wirelessly with handheld device 40, audit device 54 and handheld device 40 may include respective Bluetooth transceivers (either add-on devices or integrated communications modules) and/or 802.11 transceivers (either add-on devices or integrated communications modules). In part for purposes of failover or redundancy, vending machine 50 and handheld device 40 may also include wired or wire line communication connection capabilities.

In addition to DEX data and MDB data, audit device 54 may record and store other transactions or activities associated with vending machine 50. For example audit device 54 may record information concerning transactions such as date and time of each engagement and disengagement of electronic lock 66 and identification of handheld device 40 which initiated engagement and/or disengagement of electronic lock 66.

When handheld device 40 and audit device 54 communicate with each other over wireless communication link 76, DEX data and MBD data stored in memory 56 may be transferred on demand to handheld device 40. In addition, handheld device 40 may include one or more software applications 44 operable to command audit device 54 to allow access to vending machine 50 by disengaging or opening electronic lock 66. For remotely located equipment that does not include vending machine controller 32 and/or audit device 54, handheld device 40 may be used to directly communicate with and disengage an electronic lock to provide access to interior portions of such remotely located equipment.

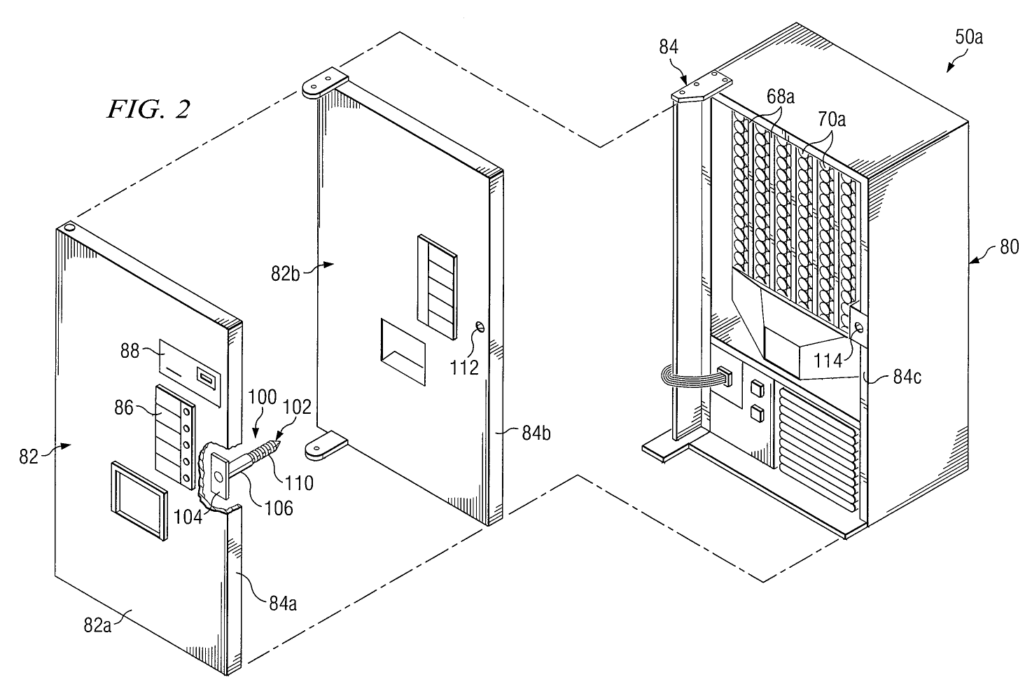

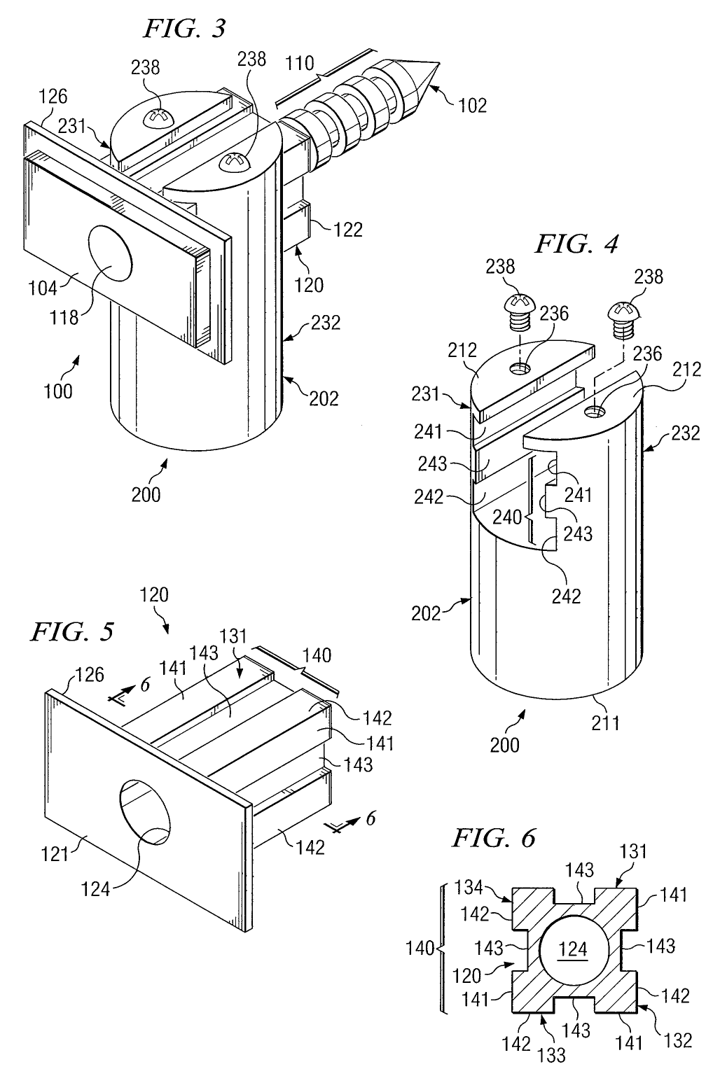

Vending machine 50a such as shown in FIG. 2 may be used to provide a wide variety of products and/or services to end users after receiving appropriate payments. Various components of communication system 20 such as shown in FIG. 1 may be satisfactorily used with vending machine 50a. An electronic module and lock assembly incorporating various teachings of the present disclosure may also be used with vending machine 50a. Electronic modules and lock assemblies incorporating teachings of the present disclosure may be used with various types of remotely located equipment. Electronic lock 66 as shown in FIG. 1, lock assembly 100 and electronic module 200 as shown in FIGS. 3-7 are only representative of some embodiments.

For some applications vending machine 50a may include enclosure 80 and door assembly 82 defined in part by outer door 82a and inner door 82b. Various types of frame and hinge assemblies 84 may be satisfactorily used to mount door assembly 82 with enclosure 80. For some applications inner door 82b may include various types of insulating materials and/or gaskets operable to form satisfactory seals with adjacent portions of frame 84c of enclosure 80. For some applications outer door 82a may include frame 84a and inner door 82b may include frame 84b.

Various types of vending hardware such as inventory storage racks 68a may be disposed within enclosure 80. Various products (inventory) such as soft drink cans 70a may be disposed within respective racks 68a. Product or service selection panel 86 may be disposed on an exterior portion of outer door 82a. Payment selection panel and/or change making panel 88 may also be disposed on an exterior portion of outer door 82a.

For some applications vending machine 50a may have been initially manufactured and placed in service at a remote location with a vending machine controller having limited data transmission capability and a conventional, mechanical lock assembly. One of the benefits of the present disclosure may include the ability to upgrade existing vending machines by installing audit device 54 (See FIG. 1) and/or modifying a conventional, mechanical lock assembly (not expressly shown) by attaching an electronic module thereto. For example, audit device 54 may be added to vending machine 50a to supply electrical power and/or digital control signals to an electronic module as previously discussed with respect to vending machine 50. For other applications an electronic module may be directly connected with the vending machine controller (not expressly shown) of vending machine 50a if the existing vending machine controller has capabilities similar to audit device 54.

Various components of lock assembly 100 which will be discussed later in more detail may correspond with a conventional, mechanical lock assembly installed during the manufacture of vending machine 50a. For other applications lock assembly 100 and electronic module 200 may be installed within vending machine 50a at the time of initial manufacture.

Various components of lock assembly 100 may be mounted on and/or attached with associated components of outer door 82a, inner door 82b and enclosure 80. Lock assembly 100 may include generally T-shaped handle 102 defined in part by plate 104 and lock post or lock screw 106. Lock post 106 may be generally described as having an elongated, cylindrical configuration sized to be received within opening 112 of inner door 82b and locking receptacle 114 provided as part of frame assembly 84c on enclosure 80. Locking receptacle 114 may be disposed within and securely engaged with portions of frame 84c.

A plurality of locking threads or locking grooves 110 may also be formed on exterior portions of lock post 106 spaced from plate 104. Plate 104 may be used as a handle to allow rotation of lock post 106 to engage threads or locking grooves 110 disposed on the exterior of lock post 106 with threads, locking teeth and/or locking grooves (not expressly shown) provided in locking receptacle 114 of enclosure 80.

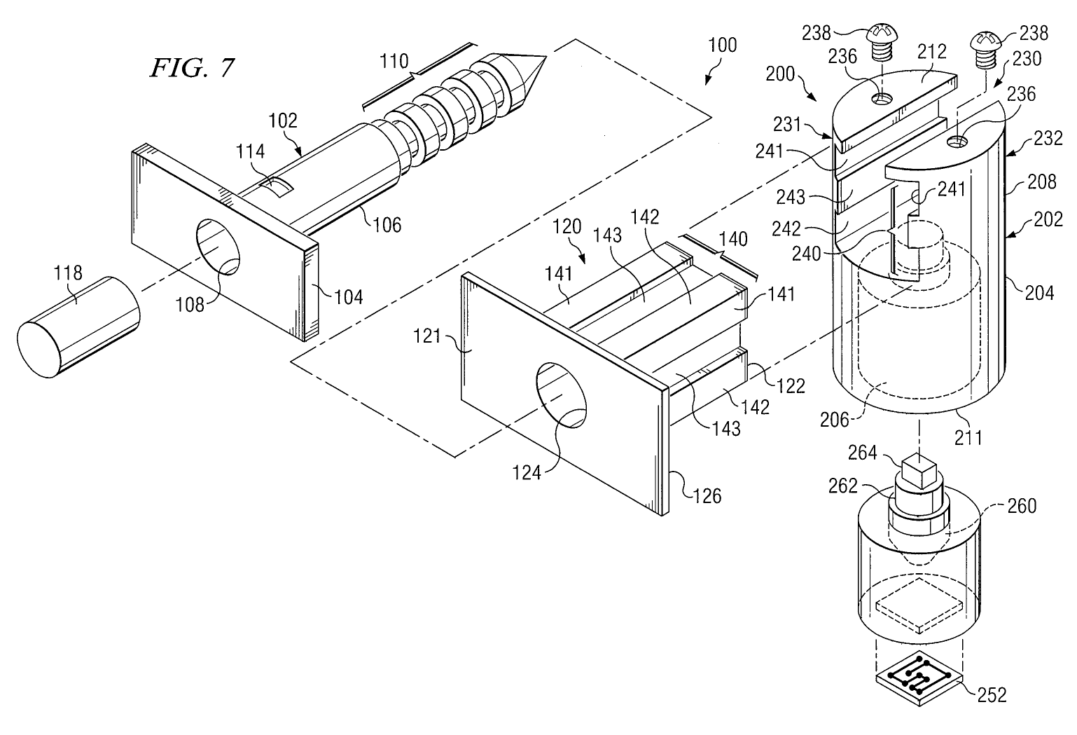

For some applications portions of lock post 106 adjacent to plate 104 may have a generally hollow configuration defined in part by longitudinal bore 108. See FIG. 7. When used as a mechanical locking device, various types of locking cylinders and other mechanical locking mechanisms (not expressly shown) may be disposed within longitudinal bore 108. A conventional, mechanical key (not expressly shown) may be inserted into the locking cylinder to lock and unlock door assembly 82.

This type of mechanical locking device or lock assembly may be converted to an electromechanical lock assembly, for example, by releasably engaging electronic module 200 with lock assembly 100. The resulting combination may sometimes be described as a “electromechanical lock assembly.”

Locking devices, lock assemblies, electronic locks, electromechanical lock assemblies and electronic modules may include a wide variety of components. For embodiments such as shown in FIGS. 3-7 lock assembly 100 may include generally T-shaped handle 102 and lock housing or first housing 120. Electronic module 200 may include electronic housing or second housing 202, electronic circuit or circuits 252 and solenoid 260. See FIG. 7.

Housing 120 of lock assembly 100 may be defined in part by first end 121 and second end 122. Longitudinal bore 124 may extend through housing 120 between first end 121 to second end 122. For some applications first end 121 of housing 120 may be defined in part by plate 126. Plate 126 may have a generally rectangular configuration. For some applications plate 126 may have dimensions which are larger than corresponding dimensions of plate 104 of generally T-shaped handle 102. In addition, plate 126 may have a rectangular depression slightly larger than plate 104 such that until plate 104 is free to move outward in the longitudinal direction (i.e., after the locking mechanism has disengaged), it cannot be rotated. The dimensions of longitudinal bore 124 may be selected to be compatible with inserting portions of lock post 106 therethrough and rotating lock post 106 within longitudinal bore 124.

Various components associated with frame 84a of outer door 82a may be securely engaged with plate 126 and other portions of housing 120. Outer door 82a may also include a recessed portion (not expressly shown) with plate 126 disposed therein such that when locking assembly 100 is in its first, locked position, plate 104 will be disposed immediately adjacent to plate 126 and generally flush with exterior portions of outer door 82a (not expressly shown).

For some applications housing 120 may be described as having a generally square cross section with longitudinal bore 124 extending therethrough. (See FIG. 6). Various profiles may be formed in exterior portions of housing 120. For some embodiments such as shown in FIGS. 5 and 6, exterior portions of housing 120 may have generally similar profiles formed therein. For example, housing 120 may include first exterior surface 131, second exterior surface 132, third exterior surface 133 and fourth exterior surface 134. Each exterior surface 131, 132, 133 and 134 may include approximately the same general profile 140. For embodiments such as shown in FIGS. 5, 6 and 7 each profile 140 may be defined in part by respective channel 143 disposed between respective first land 141 and second land 142.

Various components associated with electronic module 200 may be disposed within electronic housing 202. For some applications housing 202 may be described as having a generally cylindrical configuration defined in part by first portion 204 having cavity 206 disposed therein. Slot 230 may be formed in second portion 208 of housing 202 adjacent to cavity 206. As discussed later in more detail, various dimensions associated with slot 230 may be selected to be compatible with exterior portions of an associated lock assembly or locking device.

Housing 202 may also be defined in part by first end 211 and second end 212. For embodiments such as shown in FIGS. 3, 4 and 7, chamber 206 may be formed in first portion 204 of housing 202 extending from first end 211. Slot 230 may be formed in second portion 208 extending between first portion 204 and second end 212 of housing 202.

For some applications slot 230 may be generally described as having first leg 231 and second leg 232. Various profiles may be formed on interior portions of each leg 231 and 232. For embodiments such as shown in FIGS. 4 and 7 respective profiles 240 may be formed on respective interior surfaces of slot 230. Each profile 240 may be defined in part by land 243 with first channel 241 and second channel 242 disposed on opposite sides thereof. Dimensions of each profile 140 associated with housing 120 may be selected to be compatible with each profile 240 of slot 230.

For example, dimensions associated with first land 141 and second land 142 may be selected to be compatible with first channel 241 and second channel 242. Also, dimensions associated with channel 143 of each profile 140 may be selected to be compatible with sliding engagement with land 243 of profile 240. Thus, profiles 240 of slot 230 may be attached with either exterior surface 131, 132, 133 and/or 134 of lock housing 120. As a result the orientation of electronic module 200 relative to lock assembly 100 may be adjusted based on the configuration and dimensions associated with a door or other type of closure used to limit access to remotely located equipment.

For some applications, exterior surfaces 131, 132, 133 and/or 134 of housing 120 may have only a single channel or longitudinal groove formed therein (not expressly shown). Legs 231 and 232 of slot 230 may have only a single land or ridge sized to be received within respective channels in housing 120. For other applications exterior surfaces 131, 132, 133 and 134 of housing 120 may have respective profiles similar to profiles 240 formed within slot 230. For this embodiment slot 230 may have profiles similar to profiles 140 formed on the exterior of housing 120. For still other further applications housing 120 may be formed with only one profile formed on one exterior surface and slot 230 may be formed with only one matching profile. Other variations of profiles may also be satisfactorily used to engage an electronic module with a locking device or lock assembly in accordance with teachings of the present disclosure.

Various types of engagement devices may be satisfactorily used to releasably engage an electronic module with a lock assembly in accordance with teachings of the present disclosure. For embodiments such as shown in FIGS. 3, 4 and 7 each leg 231 and 232 at end 212 of housing 202 may include respective threaded opening 236 sized to receive respective set screw 238 therein.

As shown in FIG. 7 lock post 106 may be inserted into longitudinal bore 124 of housing 120. Profiles 240 formed in slot 230 of housing 202 may be slidably engaged with respective profiles 140 of housing 120. For embodiments such as shown in FIGS. 3 and 7, profile 140 on exterior surface 134 may be engaged with corresponding profile 240 formed on interior portions of first leg 231. In a similar manner profile 140 formed on exterior surface 132 may be slidably engaged with profile 240 formed on interior portions of second leg 232. Respective set screws 238 may then be engaged with respective threaded openings 236 to clamp or to be securely engaged with adjacent portions of profiles 140 and 240 with each other.

Since profiles 140 and 240 fit relatively snugly with each other, increased engagement of set screws 238 with respective openings 236 may be used to securely engage housing 202 with housing 120. The close fit between profiles 140 and 240 also helps to minimize any deforming or damage which may occur during engagement of set screws 238 extending through openings 236 with adjacent portion of profile 140. For example, without the close fit of land 243 into associated channel 143, engagement device 238 may cause deformation of lands 141 and 142. A wide variety of engagement devices other than set screws 238 may be satisfactorily used.

Various electrical leads (not expressly shown) may extend from first end 211 of housing 202. The electrical leads may be used to provide electrical power and control signals from associated audit device 54 (or a vending machine controller having similar capabilities) to one or more electronic circuits 252. Solenoid 260 may be disposed within cavity 206 adjacent to second portion 208. Solenoid 260 may include rod or plunger 262. A spring (not expressly shown) may also be disposed within solenoid 260 to bias or cause end 264 of plunger 262 to normally extend from solenoid 260 such as shown in FIG. 7. The dimensions of end 264 may be selected to be compatible with opening 114 in lock post 106.

When electronic circuit 252 energizes solenoid 260, plunger 262 may be retracted which allows disengagement of end 264 from opening 114 formed in lock post 106. Plate 104 may then be used to rotate lock post 106 to disengage locking grooves 110 from receptacle 114. Door assembly 82 may then be opened and interior portions of vending machine 50a serviced. After servicing of vending machine 50a has been completed, door assembly 82 may be closed and lock post 106 re-engaged with receptacle 114. Electronic circuit 252 may then be de-energized which will result the spring extending plunger 262 from solenoid 260 to re-engage end 264 with opening 114 in lock post 106.

As previously noted, a mechanical locking cylinder may be initially disposed within opening or bore 108 of lock post 106. The locking cylinder (not expressly shown) may allow insertion of a mechanical key to extend (lock) and retract (unlock) a bolt (not expressly shown) relative to opening 114. Extending the lock bolt will prevent rotation of generally T-shape handle 102. Retracting the lock bolt will allow rotation of generally T-shaped handle 102. During the process of attaching electronic module 200 with lock assembly 100, the mechanical locking cylinder may be removed and generally cylindrical plug 118 may be disposed within longitudinal bore 108.

Various examples of electrical circuits and electronic components which may be provided as part of electronic circuit 252 are described in copending U.S. patent application Ser. No. 11/277,272 entitled “Apparatus and Method for Controlling Access to Remotely Located Equipment.”

For some applications electronic circuit 252 may be operable to receive electrical power from audit device 54 and to communicate data with audit device 54. For some applications electronic circuit 252 may function as an access control module (ACM) operable to prevent unauthorized activation of lock assembly 100 until after appropriate electronic signals have been communicated between audit device 54 and electronic circuit 252. For example, audit device 54 may send a signal to electronic circuit 252 requesting confirmation of a serial number or other identifier associated with electronic circuit 252 prior to providing electrical power to energize solenoid 260.

Although the present disclosure and its advantages have been described in detail, it should be understood that various changes, substitutions and alterations may be made thereto without departing from the spirit and scope of the disclosure as defined by the following claims.

What is claimed is:

1. An apparatus for engaging an electronic module with a lock assembly comprising:
a housing having a first end and a second end with at least portions of the electronic module disposed within the housing proximate the first end;
a slot formed in and extending through the housing proximate the second end;
at least one land operable to be received within at least one channel;
at least one engagement device disposed in the housing;
the engagement device operable to releasably engage the land and the channel with each other; and
each land and the associated channel having a relatively snug fit to minimize deforming by the engagement device.

2. The apparatus of claim 1 further comprising:
the land formed in a portion of the slot; and
the channel formed in a portion of the lock assembly.

3. The apparatus of claim 2 further comprising:
the land formed in a portion of the lock assembly; and
the channel formed in a portion of the slot.

4. The apparatus of claim 1 further comprising:
exterior portions of the lock assembly having at least one profile defined in part by a first land and a second land with a first channel disposed therebetween;
the slot having at least one profile defined in part by a second channel and a third channel with a third land disposed therebetween; and
each profile of the lock assembly operable to be slidably received within at least one profile of the slot.

5. The apparatus of claim 4 further comprising:
the lock assembly having at least one portion with a generally square cross section; and
the slot in the housing having a width and length operable to slidably receive the portion of the lock assembly having the generally square cross section.

6. The apparatus of claim 5 further comprising:
the portion of the lock assembly having the generally square cross section defined by four sides; and
each side of the lock assembly having substantially the same profile.

7. The apparatus of claim 6 further comprising:
the slot defined in part by a first interior surface and a second interior surface;
each interior surface of the slot having substantially the same profile; and
each profile of the slot operable to respectively receive one of the profiles of the generally square cross section of the lock assembly.

8. The apparatus of claim 1 wherein the electronic module further comprises an access control module (ACM).

9. The apparatus of claim 1 further comprising the at least one engagement device disposed in the second end of the housing.

10. The apparatus of claim 1 further comprising:
the slot defined in part by a first leg and a second leg extending generally parallel with each other from the first portion of the housing;
each leg terminating at the second end of the housing; and
a respective engagement device disposed in each leg proximate the second end of the housing.

11. An apparatus for securely engaging a housing containing at least one electronic circuit with a lock assembly comprising:
the at least one electronic circuit disposed within a first portion of the housing;
a slot formed in and extending through a second portion of the housing proximate the first portion of the housing;
a plurality of lands and grooves formed within the slot;
a plurality of lands and grooves formed on exterior portions of the lock assembly;
the lands and grooves of the slot sized to receive respective lands and grooves of the lock assembly;
respective engagement devices operable to releasably engage the respective lands and grooves of the lock assembly with the lands and grooves of the housing; and
each land and the associated groove having a relatively snug fit to minimize deforming by the engagement device.

12. The apparatus of claim 11 wherein the housing further comprises:
a first end with the at least one electronic circuit disposed proximate thereto; and
a second end with the engagement devices disposed proximate thereto.

13. The apparatus of claim 11 further comprising:
the at least one electronic circuit operably coupled with an electrical actuator disposed within the first portion of the housing;
a plunger having a first, extended position and a second, retracted position relative to the electrical actuator;
one end of the plunger operable to engage a portion of the lock assembly when the plunger is in its first, extended position; and
the at least one electronic circuit operable to energize the solenoid and shift the plunger from its first extended, position to its second, retracted position to release engagement between the one end of the plunger and the portion of the lock assembly.

14. The apparatus of claim 11 further comprising multiple electronic circuits disposed in the housing.

15. A method for controlling access to remotely located equipment comprising:
releasably engaging an electronic module with a lock assembly by slidably engaging a first profile formed on an exterior portion of the lock assembly with a matching profile formed in a slot of the electronic module;
forming a snug fit between the first profile and the second profile to minimize deforming or damage while releasably engaging the electronic module with the lock assembly; and
communicating electronic signals with the electronic module to disengage of the lock assembly to allow access to the remotely located equipment and to engage the lock assembly to limit access to the remotely located equipment.

16. The method of claim 15 wherein controlling access to the remotely located equipment further comprises releasably securing the portion of the lock module within the slot using an engagement device.

17. The method of claim 15 wherein communicating electronic signals further comprises communicating the electronic signals using wire-line transmission techniques.

18. The method of claim 15 wherein communicating the electronic signals further comprises communicating the electronic signals using wireless transmission techniques.

19. The method of claim 15 wherein communicating electronic signals further comprises communicating the electronic signals using both wireline transmission techniques and wireless transmission techniques.

20. A method for forming an electronic module operable to be releasably engaged with a lock assembly comprising:
forming a slot in the electronic module sized to receive a portion of the lock assembly therein; and
forming at least one profile within the slot with a configuration and dimensions compatible having a close fit with portions of a matching profile of the lock assembly to minimize deforming of the profiles when the electronic module is releasably engaged with the lock assembly.

21. The method of claim 20 further comprising:
forming the electronic module with a first end and a second end;
installing at least one electronic circuit in the electronic module proximate the first end; and
forming the slot in the electronic module extending from the second end.

22. The method of claim 20 further comprising forming a pair of profiles in the slot operable to be slidably engaged with corresponding profiles on exterior portions of the lock assembly.

23. The method of claim 20 wherein forming each profile in the slot further comprises forming a first channel and a second channel with a land disposed therebetween on an interior portion of the slot.
